(19) United States
(12) Patent Application Publication
(10) Pub. No.: US 2026/0299920 A1
(43) Pub. Date: Oct. 1, 2026

(54) FIRMWARE UPDATE RECOVERY

(71) Applicant: Toshiba Global Commerce Solutions, Inc., Durham, NC (US)

(72) Inventors: Te Chia Tsai, New Taipei City (TW); Wei-Yi Hsuan, Taipei (TW); Chi-Huang Wang, New Taipei City (TW); Yi-Sheng Lee, New Taipei City (TW)

(73) Assignee: Toshiba Global Commerce Solutions, Inc., Durham, NC (US)

(21) Appl. No.: 19/096,049

(22) Filed: Mar. 31, 2025

(51) Int. Cl. G06F 8/65

(52) U.S. Cl. CPC G06F 8/65

(57) ABSTRACT

Systems and methods of performing firmware update recovery are provided. In one exemplary embodiment, a method is performed by a bootloadable device operationally coupled to a bootloader device over first and second interfaces. Further, the bootloadable device includes a processing circuitry operationally coupled to a first non-volatile memory having a boot program and a second non-volatile memory having a set of sequential memory blocks with a first sequential memory block having a base address that corresponds to an entry point from which the processing circuitry can initially fetch code for execution responsive to a power-up or reset of the bootloadable device. The method includes programming, by the boot program executed by the processing circuitry, the bootloading validation program at the entry point of the second non-volatile memory.

### BACKGROUND

A bootloader performs bootloading to initialize a system by loading the necessary software, typically the operating system or firmware, into memory upon startup. A bootloader, stored in non-volatile memory such as FLASH memory, is responsible for managing this process, ensuring that the correct program is loaded and executed. It often includes a mechanism for updating firmware by writing new code to FLASH memory while preserving system integrity. To ensure the reliability of the loaded software, a checksum is commonly used to verify data integrity, detecting corruption or errors before execution. This prevents system failures due to faulty or incomplete updates.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a system operable to perform bootloading in accordance with various aspects as described herein.

FIG. 2A illustrates another embodiment of a bootloader device in accordance with various aspects as described herein. FIG. 2B illustrates another embodiment of a bootloadable device in accordance with various aspects as described herein.

FIGS. 3A-3B illustrate embodiment of a method performed by a bootloader device of performing bootloading in accordance with various aspects as described herein. FIG. 3C illustrates one embodiment of a method performed by a bootloadable device of performing bootloading in accordance with various aspects as described herein.

FIG. 4 illustrates another embodiment of a device in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

The present disclosure further includes, among other things, systems and methods of performing bootloading. For instance, upon reset or power-up, the processing circuitry of a bootloadable device can initialize by executing a predefined sequence of instructions stored in a first non-volatile memory (e.g., FLASH, ROM). This typically begins with a hardware or firmware-based bootstrapping routine that checks for conditions indicating whether to enter bootloader mode or proceed with a normal operation mode. If a valid boot condition is detected —such as a specific pin state, received command, or corrupted firmware—the circuitry can transfer control to a boot program residing in a dedicated memory region of non-volatile memory. The boot program can then establish communication with a bootloader device such as over a first interface (e.g., UART, USB, SPI, I2C, or the like) to receive a firmware module (e.g., program instructions or code, data). As each block of the firmware module is received, the processing circuitry can verify the integrity of that block such as by using a checksum or similar validation method before writing that block to a second non-volatile memory. Each of the first and second non-volatile memory can be a distinct memory or the same memory.

Various validation methods ensure data integrity during bootloading or memory operations, with checksums being one of the simplest techniques. A more robust alternative is the Cyclic Redundancy Check (CRC), which is widely used in communication protocols and memory verification. Hashing algorithms like SHA-256 or MD5 provide stronger integrity checks by generating unique fingerprints of the data. For security-sensitive applications, a Message Authentication Code (MAC) or digital signature can verify both integrity and authenticity, ensuring firmware has not been tampered with. Error correction techniques such as Reed-Solomon coding or Hamming codes not only detect but can also correct errors in stored or transmitted data. Other approaches include redundant data comparison, where data is written multiple times and checked for consistency, and parity checks, which detect single-bit errors. The choice of validation method depends on the application's requirements for reliability, security, and computational efficiency. Once the firmware module is received and stored in the second non-volatile memory, the bootloadable device can perform an integrity check (e.g., checksum verification) before restarting and executing the newly loaded firmware module. During the next power-up or reset sequence of the bootloadable device, if no boot conditions are met, the processing circuitry can jump to the entry point of the newly loaded firmware module in the second non-volatile memory, initializing the system and executing the new firmware code.

During bootloading, flashing refers to the process of erasing and programming FLASH memory, a type of non-volatile storage commonly used for firmware and organized into a hierarchical structure consisting of memory cells, pages, blocks, planes, and dies. At the lowest level, memory cells store data using floating-gate transistors, with each cell capable of holding one or more bits depending on the type of Flash memory (SLC, MLC, TLC, or QLC). These cells are grouped into pages, which serve as the smallest unit for read and write operations. Pages typically range from 4 KB to 16 KB in size. A collection of pages forms a block, which is the smallest unit that can be erased in Flash memory. Block sizes generally range from 256 KB to several megabytes and contain multiple pages, usually 64 to 256 pages per block. To enhance parallelism and performance, multiple blocks are grouped into planes, and multiple planes are integrated into a die, which represents a single silicon chip. A complete Flash memory package may contain multiple dies to increase storage capacity. FLASH memory must be erased before new data can be written, and this process typically occurs in predefined block sizes, which vary depending on the memory type. For example, NOR FLASH often has small sector sizes ranging from 4 KB to 64 KB, making it ideal for frequent updates. In contrast, NAND FLASH uses larger block sizes of 128 KB to several megabytes, optimizing it for high-density storage but requiring more complex management. Selecting the appropriate FLASH memory and block size impacts firmware update efficiency, power consumption, and overall system performance.

A bootloader device can perform a hard reset or soft reset of a bootloadable device to initiate the bootloading process or apply firmware updates. A hard reset is typically achieved by directly controlling the reset pin of the bootloadable device, either by pulling it low via a dedicated hardware connection or by briefly cutting and restoring power. This forces the device to restart from its initial power-on state, clearing all volatile memory. In contrast, a soft reset is performed using software commands sent over the first interface. The bootloader device may send a specific reset command to trigger a software interrupt or instruct the bootloadable device to execute a reset sequence through its internal watchdog timer. A soft reset allows for controlled restarts without fully cycling power, making it useful for seamless firmware updates and debugging.

The present disclosure further includes, among other things, systems and methods of performing firmware update recovery. For instance, a bootloader device can become unresponsive during boot-up if a bootloadable device does not boot-up. Further, other system devices may be unable to detect the bootloadable device not booting-up. For bootloadable devices that have limited non-volatile memory capacity such as those configured to store only a single firmware file, solutions having a fail-safe mechanism or maintaining multiple firmware versions are not feasible. If a failure occurs during firmware transfer from the bootloader device to the bootloadable device, the system hang-up or cause a delay, significantly affecting system performance and user experience. In one example, to resolve without adding any additional hardware components that would increase hardware costs, a software-based assurance mechanism can be applied by modifying the firmware of the bootloadable device to assert a general purpose input/output (GPIO) pin before initiating a firmware update, enabling the bootloader device to monitor the state of the GPIO pin. If the state of the GPIO pin does not change within a predefined time (e.g., 1, 5, 10, 20, 30 seconds), the bootloader device triggers a recovery process, preventing indefinite waiting, ensuring system responsiveness, improved reliability and reduced boot delays without requiring additional hardware modifications.

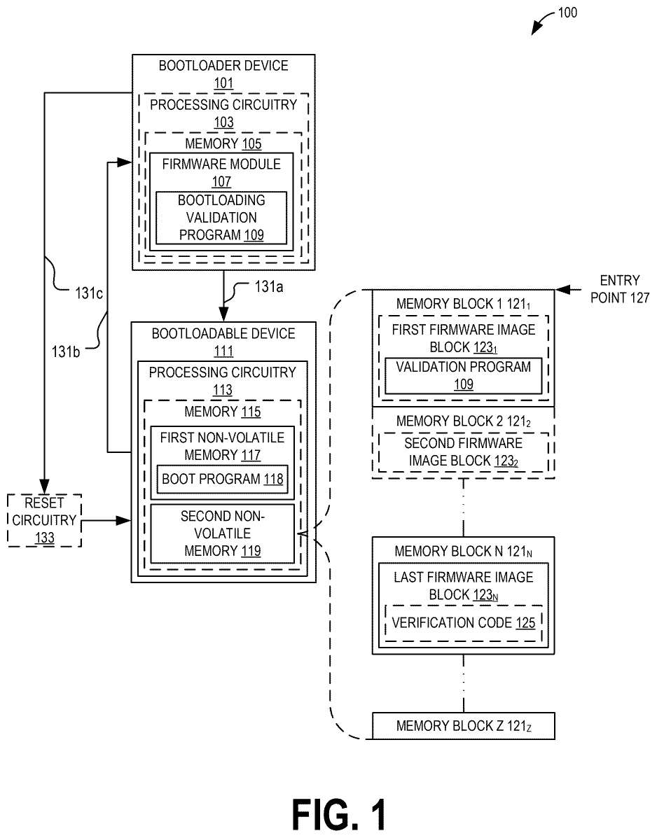

FIG. 1 illustrates one embodiment of a system 100 operable to perform bootloading in accordance with various aspects as described herein. In FIG. 1, the system 100 can include a bootloader device 101 (e.g., embedded controller device, microcontroller device, ASIC, DSP) having processing circuitry 103 operationally coupled to memory 105 that includes a firmware module 107 (e.g., application) and a bootloading validation program 109. Further, the firmware module 107 can include executable code, configuration data, lookup tables, calibration data, security data, authentication data, user data, system data, firmware update data, the bootloading validation program 109, the like, or any combination thereof. The system 100 can also include a bootloadable device 111 (e.g., embedded controller device, microcontroller device, ASIC, DSP) having processing circuitry 113 operationally coupled to memory 115 that includes a first non-volatile memory 117 (e.g., ROM, FLASH) having a boot program 118 and a second non-volatile memory 119 (e.g., FLASH) that includes a set of sequential memory blocks 121-{1, . . . , Z} having a certain block size (e.g., 64 kB, 128 kB, 256 kB, 512 kB, 1MB, 2MB, 4MB). Each of the first and second non-volatile memory 117, 119 can be a distinct memory or the same memory. The boot program 118 can be configured to initialize the bootloadable device 111 when powered on or reset (e.g., soft reset, hard reset) by loading firmware into the first or second non-volatile memory 117, 119. The bootloading validation program 109 can be configured to indicate, when executed by the processing circuitry 113 of the bootloadable device 111, to the bootloader device 101 via second interface 131b, whether the bootloadable device 111 has successfully bootloaded. The firmware module 107 can be represented by a set of sequential firmware blocks 123-{1, . . . , N}, with the size of each firmware block 123-{1, . . . , N} corresponding to the size of each sequential memory block 121-{1, . . . , Z} of the second non-volatile memory 119 of the bootloadable device 111.

In FIG. 1, the bootloader device 101 and the bootloadable device 111 can share first, second and third interfaces 131a-c. In one example, the first interface 131a is a serial interface (e.g., UART, USB, SPI, I2C), the second interface 131b is a GPIO interface, and the third interface 131c is a hard reset interface. In yet another example, the first interface 131a can be configured to enable communications between the bootloader device 101 and the bootloadable device 111, the second interface 131b can be configured to enable the bootloadable device 111 to indicate, to the bootloader device 101, whether the bootloadable device 111 has successfully bootloaded 107 into the second non-volatile memory 119 or whether the bootloadable device 111 has or has not bootloaded, and the third interface 131c can be configured to enable the bootloader device 101 to enable a hard reset of the bootloadable device 111 such as via the reset circuitry 133. In one example, the reset circuitry 133 can be a watchdog timer reset circuitry configured to generate a reset signal to restart the bootloadable device 111 if the bootloadable device 111 does not provide an indication within a certain time period (e.g., 1 second, 2 seconds, 5 seconds, 10 seconds, 20 seconds, 30 seconds). In another example, the reset circuitry 133 can be a GPIO-controlled reset circuit configured to trigger the reset line of the bootloadable device 111. In yet another example, the reset circuitry 133 can be an open-drain reset circuitry with a pull-up resistor configured to enable the bootloader device 101 to pull the reset pin of the bootloadable device 111 low to trigger a reset of the bootloadable device 111. The bootloader device 101 can also be configured to enable a soft reset of the bootloadable device 111 via the first interface 107a. The first interface 107a, the second interface 107b, and the third interface 107c may be the same interface, different interfaces, or any combination thereof. In some embodiments, the first, second, and third interfaces 107a-c are identical interfaces. In other embodiments, each interface 107a-c is distinct. In yet other embodiments, two of the interfaces 107a-c are the same interface while the remaining interface is different.

In operation, the bootloader device 101 can perform a power-up or reset sequence to place the bootloader device 101 into a boot mode. Further, the bootloader device 101 can monitor the second interface 131b to determine whether the bootloadable device 111 has or has not bootloaded. For instance, the bootloader device 101 can monitor a certain GPIO pin of the bootloadable device 111 to determine whether the bootloadable device 111 has or has not bootloaded such as with a high signal on the certain GPIO pin indicating that the bootloadable device 111 has bootloaded and a low signal on the certain GPIO pin indicating that the bootloadable device 111 has not bootloaded. If the bootloader device 101 determines that the bootloadable device 111 has bootloaded responsive to an indication by the bootloadable device 111 via the second interface 131b that indicates the bootloadable device 111 has bootloaded, then the bootloader device 101 can configure the bootloader device 101 for a normal operation mode. However, if the bootloader device 101 determines that the bootloadable device 111 has not bootloaded such as after a certain time period (e.g., 1 second, 2 seconds, 5 seconds, 10 seconds, 20 seconds, 30 seconds) in which an indication by the bootloadable device 111 via the second interface 131b indicates that the bootloadable device 111 has not bootloaded, then the bootloader device 101 can establish communications with the bootloadable device 111 over the first interface 131a. Additionally or alternatively, the bootloader device 111 can enable a hard reset of the bootloadable device 111 over the third interface 131c such as via the reset circuitry 133 or can enable a soft reset of the bootloadable device 111 over the first interface 131a.

Furthermore, the bootloadable device 111 can execute, by the processing circuitry 113, the boot program 118 stored in the first non-volatile memory 117 responsive to the power-up or reset of the bootloadable device 111 that places the bootloadable device 111 into a boot mode. The bootloadable device 111 can erase, by the boot program 118 executed by the processing circuitry 113, the first memory block 121₁ having a bootloading validation program 124 that is stored at the entry point 127 of the second non-volatile memory 119. The base address of the first memory block 121₁ corresponds to the entry point 127 from which the processing circuitry 113 can initially fetch code for execution responsive to a power-up or reset of the bootloadable device 111. The bootloadable device 111 can establish, by the boot program 118 executed by the processing circuitry 113, communications with the bootloader device 101 over the first interface 131a. The bootloader device 101 can send, to the bootloadable device 111 over the first interface 131a, each firmware block 123-{1, . . . , N} representing the firmware module 107 with the first sequential firmware block 123₁ having a bootloading validation program 124 and a last sequential firmware block 123_{N} having a firmware module verification code 125 (e.g., checksum, CRC) to enable verification that the firmware module 107 was programmed into the second non-volatile memory 119 without any errors based on the firmware module verification code 125 included in the firmware module 107. The bootloadable device 111 can indicate, by the bootloading validation program 124 executed by the processing circuitry 113, to the bootloader device 101 over the second interface 131b, that the bootloadable device 111 has or has not bootloaded. For instance, the bootloadable device 111 can change, by the bootloading validation program 124 executed by the processing circuitry 113, a state of a certain GPIO pin of the bootloadable device 111 to a high or low state to indicate that the bootloadable device 111 has or has not bootloaded, with the certain GPIO pin being operationally coupled to the bootloader device 101.

Moreover, the bootloadable device 111 can receive, by the boot program 118 executed by the processing circuitry 113, from the bootloader device 101 over the first interface 131a, each block 123-{1, . . . , N} of the firmware module 107, with the first received block 123₁ having the bootloading validation program 109 at a base address of that block 123₁ and a last received block 123_{N} having the firmware module verification code 125 such as at the last address of that block 123_{N}. The bootloadable device 111 can verify, by the boot program 118 executed by the processing circuitry 113, that each received block 123-{1, . . . , N} was received without an error based on a block verification code (e.g., checksum, CRC) included with each received block 123-{1, . . . , N}. In addition, the bootloadable device 111 can detect or correct, by the boot program 118 executed by the processing circuitry 113, an error in each received block 123-{1, . . . , N} based on the block verification code included in that block 123-{1, . . . , N}. The bootloadable device 111 can program, by the boot program 118 executed by the processing circuitry 113, each received block 123-{1, . . . , N} from a second block 123₂ to a last block 123_{N} of the firmware module 107 to the corresponding block 121-{1, . . . , N} of the second non-volatile memory 119. Further, the bootloadable device 111 can program, by the boot program 118 executed by the processing circuitry 113, at the entry point 127, the bootloading validation program 109 of the second non-volatile memory 119 or the first block 123₁ of the firmware module 107 having the bootloading validation program 109 responsive to programming the last block 123_{N} of the firmware module 107 to the corresponding block 121-{1, . . . , N} of the second non-volatile memory 119. In addition, the bootloadable device 111 can verify, by the boot program 118 executed by the processing circuitry 113, that the firmware module was programmed into the second non-volatile memory without any errors based on the firmware module verification code 125 included in the firmware module. The bootloadable device 111 can also detect or correct, by the boot program 118, an error in the bootloading of the firmware module 107 based on the firmware module verification code 125.

In FIG. 1, in response to sending the set of sequential firmware image blocks 123-{1, . . . , N} representing the firmware module 107 to the bootloadable device 111, the bootloader device 101 can enable a soft or hard reset of the bootloadable device 111 via the respective first or third interface 131a, c, with the third interface 131c being coupled between the bootloader device 101 and the bootloadable device 111 such as via the reset circuitry 133. In response to the soft or hard reset, the bootloadable device 111 can execute, by the processing circuitry 113, commencing at the entry point 127 at the base address of the second non-volatile memory 119, the bootloading validation program 109 stored in the second non-volatile memory 119. The bootloadable device 111 can indicate, by the bootloading validation program 109 executed by the processing circuitry 113, to the bootloader device 101 via the second interface 131b, that the bootloadable device has bootloaded the firmware module 107. The bootloader device 101 can monitor the second interface 131b to determine whether the bootloadable device 111 has bootloaded. In response to determining that the bootloadable device 111 has bootloaded responsive to an indication, by the bootloadable device 111 via the second interface 131b, that the bootloadable device 111 has bootloaded, the bootable device 101 can configure the bootable device 101 in a normal operation mode.

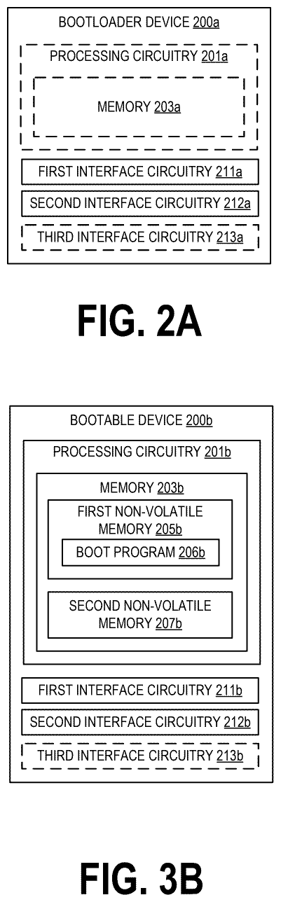

FIG. 2A illustrates another embodiment of a bootloader device 200a in accordance with various aspects as described herein. In FIG. 2A, the device 200a may include processing circuitry 201a that is operably coupled to one or more of the following: memory 203a, a first interface circuitry 211a, a second interface circuitry 212a, a third interface circuitry 213a, the like, or any combination thereof. Each of the interface circuitry 211a, 212a, 213a can be configured to communicate via any communication technology (e.g., UART, USB, SPI, I2C, GPIO, or the like). The processing circuitry 201a can be configured to perform processing described herein, such as by executing instructions stored in memory 203a. The processing circuitry 201a in this regard may implement certain functional means, units, or modules.

FIG. 2B illustrates another embodiment of a bootloadable device 200b in accordance with various aspects as described herein. In FIG. 2B, the device 200b may include processing circuitry 201b that is operably coupled to one or more of the following: memory 203b, a first interface circuitry 211b, a second interface circuitry 212b, a third interface circuitry 213b, the like, or any combination thereof. The memory 203b can include a first non-volatile memory 205b (e.g., ROM, FLASH) having a boot program 206b and a second non-volatile memory 207b (e.g., FLASH). Each of the interface circuitry 211b, 212b, 213b can be configured to communicate via any communication technology (e.g., UART, USB, SPI, I2C, GPIO, or the like). The processing circuitry 201b can be configured to perform processing described herein, such as by executing instructions stored in memory 203b. The processing circuitry 201b in this regard may implement certain functional means, units, or modules.

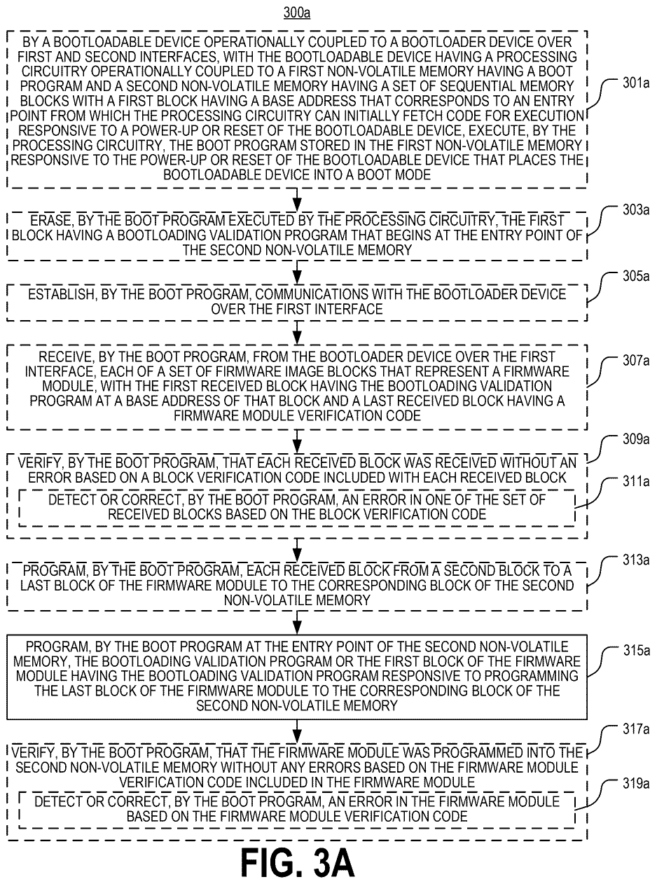

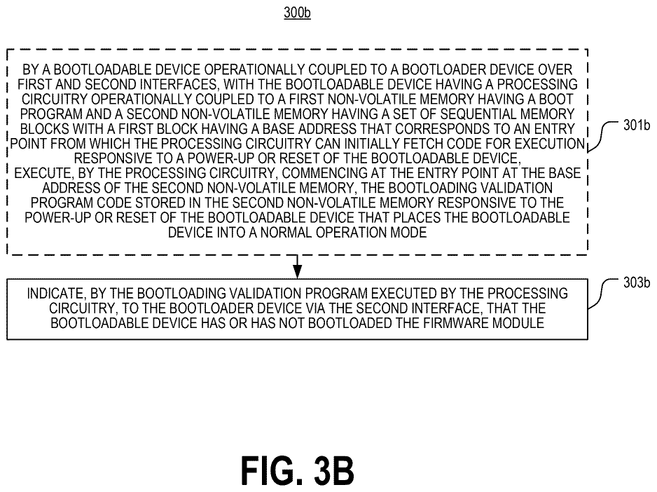

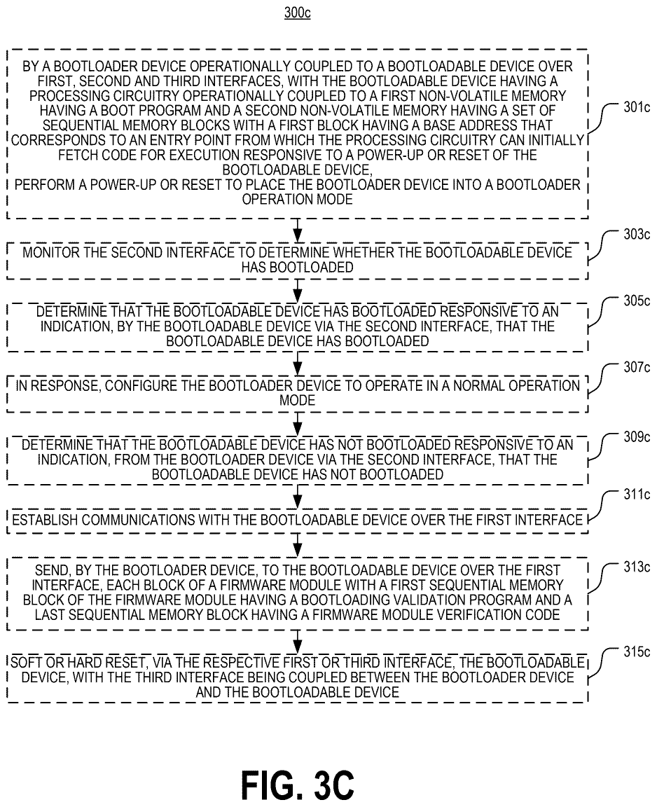

FIG. 3A illustrates one embodiment of a method 300a performed by a bootloader device of performing bootloading in accordance with various aspects as described herein. In FIG. 3A, the method 300a may start, for instance, at block 301a where it can include executing, by the processing circuitry, the boot program stored in the second non-volatile memory responsive to the power-up or reset sequence performed by the bootloadable device that places the bootloadable device into a boot mode. At block 303a, the method 300a can include erasing, by the boot program executed by the processing circuitry, the first block having a bootloading validation program that begins at the entry point of the second non-volatile memory. At block 305a, the method 300a can include establishing, by the boot program executed by the processing circuitry, communications with the bootloader device over the first interface. At block 307a, the method 300a can include receiving, by the boot program executed by the processing circuitry, from the bootloader device over the first interface, each block of a firmware module, with the first received block having the bootloading validation program at a base address of that block and a last received block having a firmware module verification code. At block 309a, the method 300a can include verifying, by the boot program executed by the processing circuitry, that each received block was received without an error based on a block verification code included with each received block. At block 311a, the method 300a can include detecting or correcting, by the boot program executed by the processing circuitry, an error in one of the set of received blocks based on the block verification code. At block 313a, the method 300a can include programming, by the boot program executed by the processing circuitry, each received block from a second block to a last block of the firmware module to the corresponding block of the second non-volatile memory. At block 315a, the method 300a includes programming, by the boot program executed by the processing circuitry, the bootloading validation program at the entry point of the second non-volatile memory or the first block of the firmware module having the bootloading validation program at the entry point responsive to programming the last block of the firmware module to the corresponding block of the second non-volatile memory. At block 317a, the method 300a can include verifying, by the boot program, that the firmware module was received without any errors based on the firmware module verification code included in the firmware module. At block 319a, the method 300a can include detecting or correcting, by the boot program, an error in the firmware module based on the firmware module verification code.

FIG. 3B illustrates one embodiment of a method 300b performed by a bootloadable device of performing bootloading in accordance with various aspects as described herein. In FIG. 3B, the method 300b may start, for instance, at block 301b where it can include executing, by the processing circuitry, commencing at the entry point at the base address of the second non-volatile memory, the bootloading validation program code stored in the second non-volatile memory responsive to the power-up or reset sequence performed by the bootloadable device that places the bootloadable device into a normal operation mode. At block 303b, the method 300b includes indicating, by the bootloading validation program executed by the processing circuitry, to the bootloader device via the second interface, that the bootloadable device has or has not bootloaded.

FIG. 3C illustrates one embodiment of a method 300c performed by a bootloadable device of performing bootloading in accordance with various aspects as described herein. In FIG. 3C, the method 300c may start, for instance, at block 301c where it can include performing a power-up or reset sequence to place the bootloader device into a bootloader operation mode. At block 303c, the method 300c can include monitoring the second interface to determine whether the bootloadable device has or has not bootloaded. At block 305c, the method 300c can include determining that the bootloadable device has bootloaded responsive to an indication, by the bootloader device via the second interface, that the bootloadable device has bootloaded. At block 307c, the method 300c can include configuring the bootloader device to operate in a normal operation mode. At block 309c, the method 300c can include determining that the bootloadable device has bootloaded responsive to an indication, by the bootloader device via the second interface, that the bootloadable device has not bootloaded. At block 311c, the method 300c can include establishing communications with the bootloadable device over the first interface. At block 313c, the method 300c can include sending, by the bootloader device, to the bootloadable device over the first interface, each block of a firmware module with a first sequential memory block of the firmware module having a bootloading validation program and a last sequential memory block having a firmware module verification code. At block 315c, the method 300c can include soft or hard resetting, via the respective first or third interface, the bootloadable device, with the third interface being coupled between the bootloader device and the bootloadable device

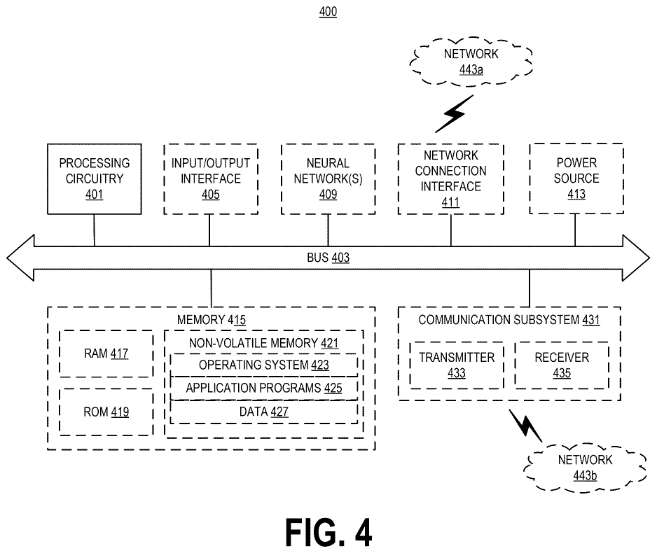

FIG. 4 illustrates another embodiment of a bootloader device or a bootloadable device 400 in accordance with various aspects as described herein. In FIG. 4, device 400 includes processing circuitry 401 that is operatively coupled over bus 403 to input/output interface 405, artificial intelligence circuitry 409 (e.g., neural network circuit, machine learning circuit), network connection interface 411, power source 413, memory 415 including random access memory (RAM) 417, read-only memory (ROM) 419 and non-volatile memory 421, communication subsystem 431, and/or any other component, or any combination thereof. In one example, the device 400 can be operatively coupled to one or more optical sensor devices over a wired communication interface (e.g., USB, Ethernet) or wireless communication interface (e.g., WiFi, Bluetooth). Further, the device 400 can be operatively coupled to one or more optical sensor devices via the network connection interface 411 or the communication subsystem 431.

The input/output interface 405 may be configured to provide a communication interface to an input device, output device, or input and output device. The device 400 may be configured to use an output device via input/output interface 405. An output device 461 may use the same type of interface port as an input device. For example, a USB port or a Bluetooth port may be used to provide input to and output from the device 400. The output device may be a speaker, a sound card, a video card, a display, a monitor, a printer, an actuator, a transducer 475 (e.g., speaker, ultrasound emitter), an emitter, a smartcard, another output device, or any combination thereof. The device 400 may be configured to use an input device via input/output interface 405 to allow a user to capture information into the device 400. The input device may include presence-sensitive display, sensor, a microphone, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, a microphone, an ultrasound sensor, another like sensor, or any combination thereof.

In FIG. 4, non-volatile memory 421 may include operating system 423, application program 425, data 427, the like, or any combination thereof. In other embodiments, non-volatile memory 421 may include other similar types of information. Certain devices may utilize all of the components shown in FIG. 4, or only a subset of the components. The level of integration between the components may vary from one device to another device. Further, certain devices may contain multiple instances of a component, such as multiple processors, memories, neural networks, network connection interfaces, transceivers, etc.

In FIG. 4, processing circuitry 401 may be configured to process computer instructions and data. Processing circuitry 401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 401 may include two central processing units (CPUs). Data may be information in a form suitable for use by a computer.

In FIG. 4, the artificial intelligence circuitry 409 may be configured to learn to perform tasks by considering examples such as performing detection, classification or identification of objects based on an image. In one example, first artificial intelligence circuitry is configured to perform activity detection. Further, second artificial intelligence circuitry is configured to perform object classification or identification. In FIG. 4, the network connection interface 411 may be configured to provide a communication interface to network 443a. The network 443a may encompass wired and/or wireless networks such as a local-area network (LAN), a wide-area network (WAN), a computer network, a wireless network, a telecommunications network, another like network or any combination thereof. For example, network 443a may comprise a Wi-Fi network. The network connection interface 411 may be configured to include a receiver and a transmitter interface used to communicate with one or more other devices over a communication network according to one or more communication protocols, such as Ethernet, TCP/IP, SONET, ATM, or the like. The network connection interface 411 may implement receiver and transmitter functionality appropriate to the communication network links (e.g., optical, electrical, and the like). The transmitter and receiver functions may share circuit components, software or firmware, or alternatively may be implemented separately.

The RAM 417 may be configured to interface via a bus 403 to the processing circuitry 401 to provide storage or caching of data or computer instructions during the execution of software programs such as the operating system, application programs, and device drivers. The ROM 419 may be configured to provide computer instructions or data to processing circuitry 401. For example, the ROM 419 may be configured to store invariant low-level system code or data for basic system functions such as basic input and output (I/O), startup, or reception of keystrokes from a keyboard that are stored in a non-volatile memory. The non-volatile memory 421 may be configured to include memory such as RAM, ROM, FLASH, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, non-volatile memory 421 may be configured to include an operating system 423, an application program 425 such as web browser, web application, user interface, browser data manager as described herein, a widget or gadget engine, or another application, and a data file 427. Non-volatile memory 421 may store, for use by the device 400, any of a variety of various operating systems or combinations of operating systems.

The non-volatile memory 421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The non-volatile memory 421 may allow the device 400 to access computer-executable instructions, application programs or the like, stored on transitory or non-transitory memory media, to off-load data, or to upload data. An article of manufacture, such as one utilizing a communication system may be tangibly embodied in the non-volatile memory 421, which may comprise a device readable medium.

The processing circuitry 401 may be configured to communicate with network 443b using the communication subsystem 431. The network 443a and the network 443b may be the same network or networks or different network or networks. The communication subsystem 431 may be configured to include one or more transceivers used to communicate with the network 443b. For example, the communication subsystem 431 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 433 and/or receiver 435 to implement transmitter or receiver functionality, respectively, appropriate to the RAN links (e.g., frequency allocations and the like). Further, transmitter 433 and receiver 435 of each transceiver may share circuit components, software, or firmware, or alternatively may be implemented separately.

In FIG. 4, the communication functions of the communication subsystem 431 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 431 may include cellular communication, Wi-Fi communication, Bluetooth communication, and GPS communication. The network 443b may encompass wired and/or wireless networks such as a local-area network (LAN), a wide-area network (WAN), a computer network, a wireless network, a telecommunications network, another like network or any combination thereof. For example, the network 443b may be a cellular network, a Wi-Fi network, and/or a near-field network. The power source 413 may be configured to provide alternating current (AC) or direct current (DC) power to components of the device 400.

The features, benefits and/or functions described herein may be implemented in one of the components of the device 400 or partitioned across multiple components of the device 400. Further, the features, benefits, and/or functions described herein may be implemented in any combination of hardware, software, or firmware. In one example, communication subsystem 431 may be configured to include any of the components described herein. Further, the processing circuitry 401 may be configured to communicate with any of such components over the bus 403. In another example, any of such components may be represented by program instructions stored in memory that when executed by the processing circuitry 401 perform the corresponding functions described herein. In another example, the functionality of any of such components may be partitioned between the processing circuitry 401 and the communication subsystem 431. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Alternatively or additionally, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Additional embodiments will now be described. At least some of these embodiments may be described as applicable in certain contexts for illustrative purposes, but the embodiments are similarly applicable in other contexts not explicitly described.

In one exemplary embodiment, a method is performed by a bootloadable device operationally coupled to a bootloader device over first and second interfaces. Further, the bootloadable device includes a processing circuitry operationally coupled to a first non-volatile memory having a boot program and a second non-volatile memory having a set of sequential memory blocks with a first sequential memory block having a base address that corresponds to an entry point from which the processing circuitry can initially fetch code for execution responsive to a power-up or reset sequence performed by the bootloadable device. The method includes programming, by the boot program executed by the processing circuitry, the bootloading validation program at the entry point of the second non-volatile memory responsive to programming a last one of the set of sequential memory blocks of a firmware module to the corresponding sequential memory blocks of the second non-volatile memory. In addition, the bootloading validation program is configured when executed by the processing circuitry to indicate to the bootloader device via the second interface that the bootloadable device has or has not bootloaded the firmware module.

According to another embodiment, the method can include executing, by the processing circuitry, the boot program stored in the second non-volatile memory responsive to the power-up or reset sequence performed by the bootloadable device that places the bootloadable device into a boot mode.

According to another embodiment, the method can include erasing, by the boot program executed by the processing circuitry, the first sequential memory block of the second non-volatile memory having the bootloading validation program that begins at the entry point of the second non-volatile memory

According to another embodiment, the method can include establishing, by the boot program executed by the processing circuitry, communications with the bootloader device over the first interface

According to another embodiment, the method can include receiving, by the boot program executed by the processing circuitry, from the bootloader device over the first interface, each of a set of sequential firmware image blocks that represents the firmware module, with a first one of the set of sequential firmware image blocks having the bootloading validation program and the last one of the set of sequential firmware image blocks having a firmware module verification code.

According to another embodiment, the method can include programming, by the boot program executed by the processing circuitry, each received sequential firmware image block from a second one to a last one of the set of sequential firmware image blocks to the corresponding one of the set of sequential memory blocks of the second non-volatile memory.

According to another embodiment, the method can include programming, by the boot program executed by the processing circuitry, the bootloading validation program or a first one of the set of sequential firmware image blocks having the bootloading validation program, at the entry point of the first sequential memory block of the second non-volatile memory responsive to programming a last one of the set of sequential firmware image blocks to the corresponding one of the set of sequential memory blocks of the second non-volatile memory.

According to another embodiment, the method can include obtaining, by the boot program executed by the processing circuitry, the firmware module verification code from the firmware module; and verifying, by the boot program executed by the processing circuitry, that the firmware module was received and programmed into the second non-volatile memory without an error based on the firmware module verification code.

According to another embodiment, the method can include indicating, by the bootloading validation program executed by the processing circuitry, to the bootloader device via the second interface, that the bootloadable device has or has not bootloaded.

According to another embodiment, the first interface can be associated with a serial interface and the second interface is associated with a GPIO interface.

According to one embodiment, a bootloadable device is operationally coupled to a bootloader device over first and second interfaces. Further, the bootloadable device includes a processing circuitry operationally coupled to a first non-volatile memory having a boot program and a second non-volatile memory having a set of sequential memory blocks with a first sequential memory block of the set of sequential memory blocks having a base address that corresponds to an entry point from which the processing circuitry can initially fetch code for execution responsive to a power-up or reset sequence performed by the bootloadable device. The bootloadable device further includes processing circuitry and a memory with the memory containing instructions executable by the processing circuitry whereby the processing circuitry is configured to program, by the boot program executed by the processing circuitry, the bootloading validation program at the entry point of the second non-volatile memory responsive to programming a last one of a set of sequential firmware image blocks that represent a firmware module to the corresponding one of the set of sequential memory blocks of the second non-volatile memory. In addition, the bootloading validation program is configured, when executed by the processing circuitry, to indicate to the bootloader device via the second interface that the bootloadable device has or has not bootloaded the firmware module.

According to another embodiment, the memory can include further instructions executable by the processing circuitry whereby the processing circuitry is configured to execute the boot program stored in the second non-volatile memory responsive to the power-up or reset sequence performed by the bootloadable device that places the bootloadable device into a boot mode.

According to another embodiment, the memory can include further instructions executable by the processing circuitry whereby the processing circuitry is configured to erase, by the boot program executed by the processing circuitry, the first sequential memory block of the second non-volatile memory having the bootloading validation program that begins at the entry point of the second non-volatile memory

According to another embodiment, the memory can include further instructions executable by the processing circuitry whereby the processing circuitry is configured to establish, by the boot program executed by the processing circuitry, communications with the bootloader device over the first interface.

According to another embodiment, the memory can include further instructions executable by the processing circuitry whereby the processing circuitry is configured to receive, by the boot program executed by the processing circuitry, from the bootloader device over the first interface, each of a set of sequential firmware image blocks that represents the firmware module, with a first one of the set of sequential firmware image blocks having the bootloading validation program and the last one of the set of sequential firmware image blocks having a firmware module verification code.

According to another embodiment, the memory can include further instructions executable by the processing circuitry whereby the processing circuitry is configured to program, by the boot program executed by the processing circuitry, each received sequential firmware image block from a second one to a last one of the set of sequential firmware image blocks to the corresponding one of the set of sequential memory blocks of the second non-volatile memory.

According to another embodiment, the memory can include further instructions executable by the processing circuitry whereby the processing circuitry is configured to program, by the boot program executed by the processing circuitry, the bootloading validation program or a first one of the set of sequential firmware image blocks having the bootloading validation program, at the entry point of the first sequential memory block of the second non-volatile memory responsive to programming a last one of the set of sequential firmware image blocks to the corresponding one of the set of sequential memory blocks of the second non-volatile memory.

According to another embodiment, the memory can include further instructions executable by the processing circuitry whereby the processing circuitry is configured to: obtain, by the boot program executed by the processing circuitry, the firmware module verification code from the firmware module; and verify, by the boot program executed by the processing circuitry, that the firmware module was received and programmed into the second non-volatile memory without an error based on the firmware module verification code.

According to another embodiment, the memory can include further instructions executable by the processing circuitry whereby the processing circuitry is configured to indicate, by the bootloading validation program executed by the processing circuitry, to the bootloader device via the second interface, that the bootloadable device has or has not bootloaded.

According to one aspect, a system includes a bootloader device and a bootloadable device operationally coupled to the bootloader device over first and second interfaces. Further, the bootloadable device includes a processing circuitry operationally coupled to a first non-volatile memory having a boot program and a second non-volatile memory having a set of sequential memory blocks with a first one of the set of sequential memory blocks having a base address that corresponds to an entry point from which the processing circuitry can initially fetch code for execution responsive to a power-up or reset sequence performed by the bootloadable device. The bootloadable device is operable to program, by the boot program executed by the processing circuitry, the bootloading validation program at the entry point of the second non-volatile memory responsive to programming a last one of a set of sequential firmware image blocks that represent a firmware module to the corresponding one of the set of sequential memory blocks of the second non-volatile memory, with the bootloading validation program being configured when executed by the processing circuitry to indicate to the bootloader device via the second interface that the bootloadable device has or has not bootloaded the firmware module.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a bootloadable device operationally coupled to a bootloader device over first and second interfaces, with the bootloadable device having a processing circuitry operationally coupled to a first non-volatile memory having a boot program and a second non-volatile memory having a set of sequential memory blocks with a first sequential memory block having a base address that corresponds to an entry point from which the processing circuitry can initially fetch code for execution responsive to a power-up or reset of the bootloadable device,
programming, by the boot program executed by the processing circuitry, at the entry point of the second non-volatile memory, a bootloading validation program responsive to programming a last one of a set of sequential firmware image blocks that represent a firmware module to a corresponding one of the set of sequential memory blocks of the second non-volatile memory, with the bootloading validation program being configured when executed by the processing circuitry to indicate to the bootloader device via the second interface that the bootloadable device has or has not bootloaded the firmware module.

2. The method of claim 1, further comprising:
executing, by the processing circuitry, the boot program stored in the second non-volatile memory responsive to the power-up or reset of the bootloadable device that places the bootloadable device into a boot mode.

3. The method of claim 1, further comprising:
erasing, by the boot program executed by the processing circuitry, the first sequential memory block of the second non-volatile memory that can have the bootloading validation program that begins at the entry point of the second non-volatile memory

4. The method of claim 1, further comprising:
establishing, by the boot program executed by the processing circuitry, communications with the bootloader device over the first interface

5. The method of claim 1, further comprising:
receiving, by the boot program executed by the processing circuitry, from the bootloader device over the first interface, each of a set of sequential firmware image blocks that represents the firmware module, with a first one of the set of sequential firmware image blocks having the bootloading validation program and the last one of the set of sequential firmware image blocks having a firmware module verification code.

6. The method of claim 1, further comprising:
programming, by the boot program executed by the processing circuitry, each received sequential firmware image block from a second one to a last one of the set of sequential firmware image blocks to the corresponding one of the set of sequential memory blocks of the second non-volatile memory.

7. The method of claim 6, further comprising:
programming, by the boot program executed by the processing circuitry, the bootloading validation program or a first one of the set of sequential firmware image blocks having the bootloading validation program, at the entry point of the first sequential memory block of the second non-volatile memory responsive to programming a last one of the set of sequential firmware image blocks to the corresponding one of the set of sequential memory blocks of the second non-volatile memory.

8. The method of claim 1, further comprising:
obtaining, by the boot program executed by the processing circuitry, a firmware module verification code from the firmware module; and
verifying, by the boot program executed by the processing circuitry, that the firmware module was received and programmed into the second non-volatile memory without an error based on the firmware module verification code.

9. The method of claim 1, further comprising:
indicating, by the bootloading validation program executed by the processing circuitry, to the bootloader device via the second interface, that the bootloadable device has or has not bootloaded.

10. The method of claim 1, wherein the first interface is associated with a serial interface and the second interface is associated with a general purpose input or output (GPIO) interface.

11. A bootloadable device, comprising:
with the bootloadable device being operationally coupled to a bootloader device over first and second interfaces, with the bootloadable device having a processing circuitry operationally coupled to a first non-volatile memory having a boot program and a second non-volatile memory having a set of sequential memory blocks with a first sequential memory block having a base address that corresponds to an entry point from which the processing circuitry can initially fetch code for execution responsive to a power-up or reset of the bootloadable device; and
wherein the bootloadable device further includes processing circuitry and a memory, the memory containing instructions executable by the processing circuitry whereby the processing circuitry is configured to:
program, by the boot program executed by the processing circuitry, at the entry point of the second non-volatile memory, a bootloading validation program responsive to programming a last one of a set of sequential memory blocks of a firmware module to a corresponding one of the set of sequential memory blocks of the second non-volatile memory, with the bootloading validation program being configured when executed by the processing circuitry to indicate to the bootloader device via the second interface that the bootloadable device has or has not bootloaded the firmware module.

12. The bootloadable device of claim 11, wherein the memory includes further instructions executable by the processing circuitry whereby the processing circuitry is configured to:
execute the boot program stored in the second non-volatile memory responsive to the power-up or reset sequence performed by the bootloadable device that places the bootloadable device into a boot mode.

13. The bootloadable device of claim 12, wherein the memory includes further instructions executable by the processing circuitry whereby the processing circuitry is configured to:
erase, by the boot program executed by the processing circuitry, the first sequential memory block of the second non-volatile memory having the bootloading validation program that begins at the entry point of the second non-volatile memory.

14. The bootloadable device of claim 12, wherein the memory includes further instructions executable by the processing circuitry whereby the processing circuitry is configured to:
establish, by the boot program executed by the processing circuitry, communications with the bootloader device over the first interface.

15. The bootloadable device of claim 11, wherein the memory includes further instructions executable by the processing circuitry whereby the processing circuitry is configured to:
receive, by the boot program executed by the processing circuitry, from the bootloader device over the first interface, each of a set of sequential firmware image blocks that represents the firmware module, with a first one of the set of sequential firmware image blocks having the bootloading validation program and the last one of the set of sequential firmware image blocks having a firmware module verification code.

16. The bootloadable device of claim 15, wherein the memory includes further instructions executable by the processing circuitry whereby the processing circuitry is configured to:
program, by the boot program executed by the processing circuitry, each received sequential firmware image block from a second one to a last one of the set of sequential firmware image blocks to the corresponding one of the set of sequential memory blocks of the second non-volatile memory.

17. The bootloadable device of claim 11, wherein the memory includes further instructions executable by the processing circuitry whereby the processing circuitry is configured to:
program, by the boot program executed by the processing circuitry, the bootloading validation program or a first one of the set of sequential firmware image blocks having the bootloading validation program, at the entry point of the first sequential memory block of the second non-volatile memory responsive to programming a last one of the set of sequential firmware image blocks to the corresponding one of the set of sequential memory blocks of the second non-volatile memory

18. The bootloadable device of claim 11, wherein the memory includes further instructions executable by the processing circuitry whereby the processing circuitry is configured to:
obtain, by the boot program executed by the processing circuitry, a firmware module verification code from the firmware module; and
verify, by the boot program executed by the processing circuitry, that the firmware module was received and programmed into the second non-volatile memory without an error based on the firmware module verification code.

19. The bootloadable device of claim 11, further comprising:
indicate, by the bootloading validation program executed by the processing circuitry, to the bootloader device via the second interface, that the bootloadable device has or has not bootloaded.

20. A system, comprising:
a bootloader device;
a bootloadable device operationally coupled to the bootloader device over first and second interfaces, with the bootloadable device having a processing circuitry operationally coupled to a first non-volatile memory having a boot program and a second non-volatile memory having a set of sequential memory blocks with a first sequential memory block having a base address that corresponds to an entry point from which the processing circuitry can initially fetch code for execution responsive to a power-up or reset of the bootloadable device;
wherein the bootloadable device is operable to:
program, by the boot program executed by the processing circuitry, at the entry point of the second non-volatile memory, a bootloading validation program responsive to programming a last one of a set of sequential memory blocks of a firmware module to a corresponding one of the set of sequential memory blocks of the second non-volatile memory, with the bootloading validation program being configured when executed by the processing circuitry to indicate to the bootloader device via the second interface that the bootloadable device has or has not bootloaded the firmware module.
